(19) United States
(12) Patent Application Publication
(10) Pub. No.: US 2014/0288899 A1
(43) Pub. Date: Sep. 25, 2014

(54) CALCULATION METHOD OF BINDING FREE ENERGY, CALCULATION DEVICE OF BINDING FREE ENERGY, PROGRAM, SCREENING METHOD OF COMPOUND

(71) Applicant: FUJITSU LIMITED, Kawasaki-shi (JP)

(72) Inventor: Yoshiaki Tanida, Kawasaki (JP)

(73) Assignee: FUJITSU LIMITED, Kawasaki-shi (JP)

(21) Appl. No.: 14/166,920

(22) Filed: Jan. 29, 2014

(30) Foreign Application Priority Data
Mar. 22, 2013 (JP) 2013-060097

(51) Int. Cl. G06F 19/12

(52) U.S. Cl. CPC G06F 19/12
USPC 703/2

(57) ABSTRACT

A calculation method of binding free energy, which includes: calculating solvation energy (ΔG₁) between a solvent and a compound; and calculating an energy change (ΔG₂) between a bound state (λ=0) where the compound and a protein are bound, and an unbound state (λ=1) where the compound and the protein are not bound, wherein the calculating the energy change (ΔG₂) includes: determining a distance (Dₜₕ), within which structure sampling is performed; calculating a change in binding energy (ΔG₂₁) between the compound and the protein within a distance equal to or shorter than the distance (Dₜₕ), calculating a change in solvation energy (ΔG₂₃) between the solvent and the compound with ignoring an influence of the protein, calculating a change in binding energy (ΔG₂₂) between the compound and the protein with interpolation, and calculating a correction term (ΔG₂₄) with respect to a standard state.

### CROSS-REFERENCE TO RELATED APPLICATIONS

This application is based upon and claims the benefit of priority of the prior Japanese Patent Application No. 2013-060097, filed on Mar. 22, 2013, the entire contents of which are incorporated herein by reference.

### FIELD

The embodiments discussed herein relate to a calculation method and calculation device of binding free energy between a protein and a compound, a program for carrying out the calculation method, and a screening method of a compound using the calculation method.

### BACKGROUND

Simulations using various calculators have currently been carried out in order to reduce enormous cost and efforts required for experimentally searching drug candidate molecules. The search of drug candidate molecules is to search compounds (ligands), which are strongly interacted with a protein associated with a target disease (disease to be targeted), as drug candidates. To this end, screening of compounds based on a special configuration of a protein has been actively performed by means of a calculator.

In the screening, the most stable conformation of a compound, especially the most stable conformation in the state where a compound is interacted with a protein, is evaluated with an energy function, to predict a binding conformation or binding ability. The method for predicting the most stable conformation of a compound varies depending on an approximation level of a calculation, and examples thereof include a molecular orbital (MO) method, a molecular mechanics (MM) method, a molecular dynamics (MD) method, and docking simulation. These methods search a conformation at which the energy becomes the minimum, and binding conformation or binding ability between a protein and a compound (ligand) is predicted based on the searched most stable conformation.

As for a general technique in the screening, disclosed are conformation analysis, high speed docking studies, calculation of binding free energy, and formation of a binding model of a compound with a target protein (see, for example, International Patent Application No. WO2003/038672).

It is very difficult to directly calculate binding free energy between a protein and a drug candidate molecule in a solvent. Therefore, binding free energy is calculated via a virtual state in which a drug candidate molecule is disappeared. In this case, the calculation has been conventionally performed with restricting a protein and a drug candidate molecule with a spring. However, the restriction with the spring involves a calculation step for optimizing a spring constant, and the calculation accuracy thereof is low, such as about ±2 kcal/mol. Therefore, there is a problem that it is difficult to predict an experimental value with chemical accuracy (up to 1.4 kcal/mol). Especially, the larger a drug candidate molecule is, the lower the accuracy is.

Accordingly, there is currently a need for a method and device for accurately calculating binding free energy between a protein and a compound, a program for carrying out the calculation method, and a method for efficiently screening a compound using the calculation method.

### SUMMARY

The disclosed calculation method of binding free energy between a compound and a protein in a solvent, the method containing:

calculating solvation energy (ΔG₁) between the solvent and the compound; and

calculating an energy change (ΔG₂) between a bound state (λ=0) where the compound and the protein are bound, and an unbound state (λ=1) where the compound and the protein are not bound,

wherein the calculating the energy change (ΔG₂) includes: determining a distance (Dₜₕ), within which structure sampling is performed, based on a distance between the compound and the protein in the bound state (λ=0);

calculating a change in binding energy (ΔG₂₁) between the compound and the protein within a distance equal to or shorter than the distance (Dₜₕ) on a state (λ=λm) that is a state between the bound state (λ=0) and the unbound state (λ=1), the state (λ=λm) including a state in which a distance between the compound and the protein is equal to or shorter than the distance (Dₜₕ),

calculating a change in solvation energy (ΔG₂₃) between the solvent and the compound in the unbound state (λ=1) and a state (λ=λn) that can be regarded as the same to the unbound state (λ=1), with ignoring an influence of the protein,

calculating a change in binding energy (ΔG₂₂) between the compound and the protein on a state between the state (λ=λm) and the state (λ=λn), with interpolating from the state (λ=λm) and the state (λ=λn), and

calculating a correction term (ΔG₂₄) with respect to a standard state, based on a volume of a space calculated from the distance (Dₜₕ).

The disclosed screening method of a compound containing:

calculating binding free energy of a protein with a plurality of compounds in accordance with the disclosed calculation method of binding free energy; and

selecting the compound based on the calculated binding free energy.

The disclosed program causes a computer to execute:

calculating solvation energy (ΔG₁) between the solvent and the compound; and

calculating an energy change (ΔG₂) between a bound state (λ=0) where the compound and the protein are bound, and an unbound state (λ=1) where the compound and the protein are not bound,

wherein the calculating the energy change (ΔG₂) includes:

determining a distance (Dₜₕ), within which structure sampling is performed, based on a distance between the compound and the protein in the bound state (λ=0);

calculating a change in binding energy (ΔG₂₁) between the compound and the protein within a distance equal to or shorter than the distance (Dₜₕ) on a state (λ=λm) that is a state between the bound state (λ=0) and the unbound state (λ=1), the state (λ=λm) including a state in which a distance between the compound and the protein is equal to or shorter than the distance (Dₜₕ),

calculating a change in solvation energy (ΔG₂₃) between the solvent and the compound in the unbound state (λ=1) and a state (λ=λn) that can be regarded as the same to the unbound state (λ=1), with ignoring an influence of the protein,

calculating a change in binding energy (ΔG₂₂) between the compound and the protein on a state between the state (λ=λm) and the state (λ=λn), with interpolating from the state (λ=λm) and the state (λ=λn), and

calculating a correction term (ΔG₂₄) with respect to a standard state, based on a volume of a space calculated from the distance (Dₜₕ).

The disclosed calculation device of binding free energy, containing:

a computer; and

a recording medium readable by the computer, where the recording medium stores therein a program for causing the computer to execute:

calculating solvation energy (ΔG₁) between the solvent and the compound; and

calculating an energy change (ΔG₁) between a bound state (λ=0) where the compound and the protein are bound, and an unbound state (λ=1) where the compound and the protein are not bound,

wherein the calculating the energy change (ΔG₁) includes:

determining a distance (Dₜₕ), within which structure sampling is performed, based on a distance between the compound and the protein in the bound state (λ=0);

calculating a change in binding energy (ΔG₂₁) between the compound and the protein within a distance equal to or shorter than the distance (Dₜₕ) on a state (λ=λm) that is a state between the bound state (λ=0) and the unbound state (λ=1), the state (λ=λm) including a state in which a distance between the compound and the protein is equal to or shorter than the distance (Dₜₕ),

calculating a change in solvation energy (ΔG₂₃) between the solvent and the compound in the unbound state (λ=1) and a state (λ=λn) that can be regarded as the same to the unbound state (λ=1), with ignoring an influence of the protein,

calculating a change in binding energy (ΔG₂₂) between the compound and the protein on a state between the state (λ=λm) and the state (λ=λn), with interpolating from the state (λ=λm) and the state (λ=λn), and

calculating a correction term (ΔG₂₄) with respect to a standard state, based on a volume of a space calculated from the distance (Dₜₕ).

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a model diagram of a thermodynamic cycle associated with the energy of ligand molecules A and B and a target protein.

FIG. 2 is a model diagram of a thermodynamic cycle associated with the energy in the state where there is no ligand molecule A in FIG. 1.

FIG. 3 is a model diagram of a thermodynamic cycle associated with the energy in the case where restriction with a spring is used.

FIG. 4 is a graph depicting one example of a result of molecular dynamics calculation related to a distance between a compound and a protein in a bound state (λ=0).

FIG. 5 is a graph depicting one example of a result of molecular dynamics calculation related to a distance between a compound and a protein in a state (λ=λm) that is between the bound state (λ=0) and the unbound state (λ=1).

FIG. 6 is a graph depicting one example of a change in binding energy associated with LJ interaction between a compound and a protein.

FIG. 7 is a diagram illustrating one example of a change in a state of a compound and a protein.

FIG. 8 is a graph depicting one example of a change in binding energy associated with Coulomb interaction between a compound and a protein.

FIG. 9 is a flow chart illustrating one example of the disclosed calculation method of binding free energy.

FIG. 10 illustrates a structural example of a hardware of the disclosed calculation device of binding free energy.

FIG. 11 is a table depicting the results of Example.

### DESCRIPTION OF EMBODIMENTS

### Calculation Method of Binding Free Energy

The disclosed calculation method of binding free energy contains at least a first step and a second step, and may further contain other steps according to the necessity.

The calculation method is a calculation method of the binding free energy between a compound and protein in a solvent.

First, outlines of the disclosed calculation method of binding free energy is explained.

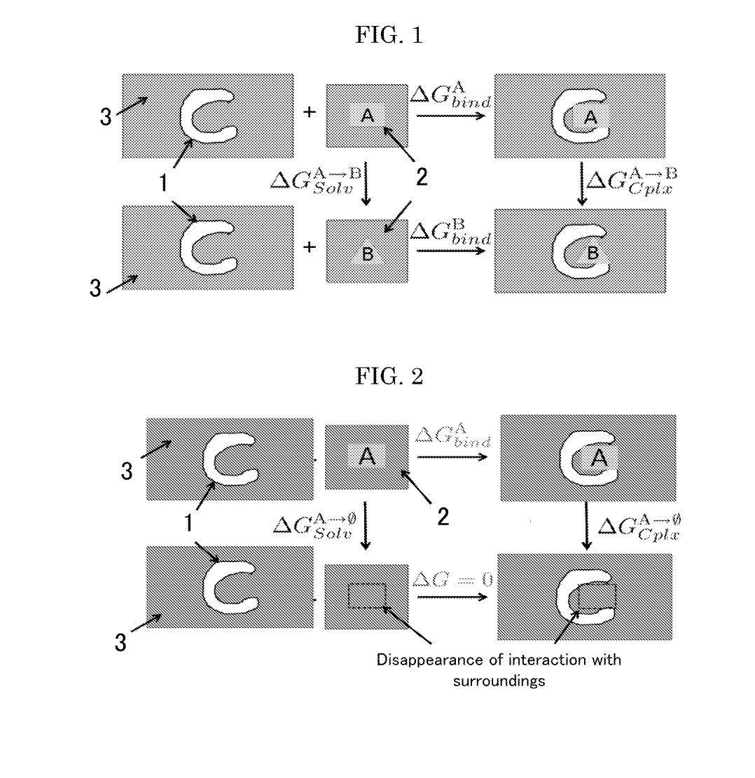

The binding free energy (ΔG^{A}_{bind}, ΔG^{B}_{bind}) of a target protein (1) with drug candidate molecule (ligand molecule) A or B (2) can be represented as in FIG. 1. In FIG. 1, the reference number “3” represents water.

The relation between ΔG^{A}_{bind} and ΔG^{B}_{bind} can be represented as follows in accordance with a thermodynamic cycle.

$$\begin{matrix}ΔΔ {G}_{bind} = Δ {G}_{bind}^{B} - Δ {G}_{bind}^{A} \\ = Δ {G}_{Cplx}^{A \to B} - Δ {G}_{Solv}^{A \to B}\end{matrix}$$

By replacing the state depicted in FIG. 1 with a state where there is no ligand molecule B, with reference to the relation depicted in FIG. 1, binding free energy of a target protein (1) and a drug candidate molecule (ligand molecule A) (2) can be represented as in FIG. 2.

ΔG^{A}_{bind} can be represented as follows:

$$Δ {G}_{bind}^{A} = Δ {G}_{Solv}^{A \to φ} - Δ {G}_{Cplx}^{A \to φ}$$

Here, the energy term (ΔG^{A→0}_{Solv}) of the right hand side of the expression above can be calculated by the first step, and the energy term (ΔG^{A→0}_{Cplx}) of the right hand side can be calculated by the second step.

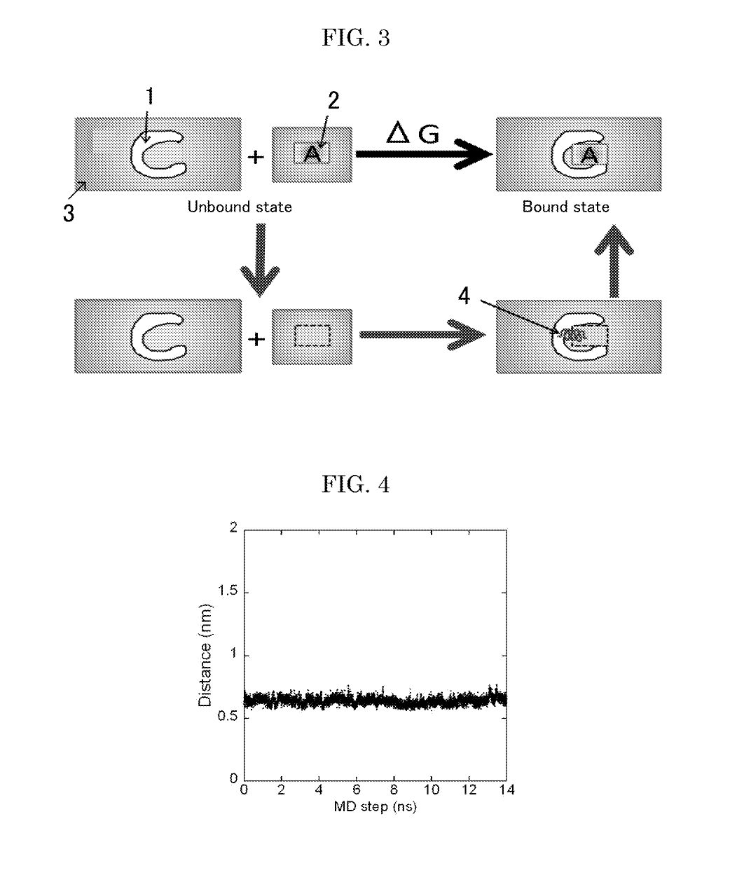

Conventionally, the energy term (ΔG^{A→0}_{Cplx}) has been calculated with a model using restriction with a spring (4) (FIG. 3). However, the restriction with a spring (4) involves a calculation step for optimizing a spring constant, and the calculation accuracy is low, such as ±2 kcal/mol.

In the disclosed calculation method of binding free energy, the restriction with a spring is not performed. Therefore, an accuracy of calculation can be improved.

When the restriction with a spring is simply not performed, a space in which drug candidate molecules are present is increased by a space in which the restriction with a spring occupies otherwise, therefore the space within which structure sampling is performed becomes large.

In order to perform structure sampling with a region where an interaction between a drug candidate molecule and a protein is strong, therefore, an appropriate distance, within which structure sampling is performed, is determined based on a distance between the drug candidate molecule and the protein in the state where the interaction thereof is the strongest (bound state). In the state where the distance between the drug candidate molecule and the protein is within the aforementioned distance, a change in binding energy between the drug candidate molecule and the protein is calculated.

In the region where there is hardly any interaction between the drug candidate molecule and the protein, moreover, the solvation energy of the drug candidate molecule in the solvent is calculated with ignoring an influence of the protein.

Moreover, the region between the region where the interaction is strong and the region where there is hardly any interaction is a region where a change is drastic, and therefore it is difficult to calculate. For this reason, the energy change in such region is calculated by interpolating from the energy change in the region where the interaction is strong and the region where there is hardly any interaction.

Furthermore, a volume correction is performed to compare with an experiment.

In the manner as described above, binding free energy can be accurately calculated.

### <First Step>

The first step is appropriately selected depending on the intended purpose without any limitation, provided that the first step is calculating solvation energy (ΔG₁) between the solvent and the compound.

One example of the first step is explained.

(1) An interaction between the compound, and the solvent surrounding the compound is determined as a binding constant λ¹.

Here, a state where the compound is present in the solvent and the compound is completely interacted with the solvent is determined as λ₁=0, and a state where the compound is present in the solvent but is not interacted with the solvent at all is determined as λ¹=1.

(2) In order to calculate ΔG₁, the state is divided as λ¹={0, λ₁, λ₂, λ₃, . . . , λₙ₋₁, 1}.
(3) A change in ΔG₁ (ΔG_{i→i+1}) when the state is changed from λ¹ᵢ to λ¹ᵢ₊₁ is calculated.
(4) ΔG₁ is obtained by adding up all ΔG_{i→i+1}.

A calculation program used here is appropriately selected depending on the intended purpose without any limitation, and examples thereof include a molecular dynamics calculation program. Examples of the molecular dynamics calculation program include gromacs (Groningen Machine for Chemical Simulations), amber (Assisted Model Building with Energy Refinement), charmm, tinker, and lammps.

Examples of the solvent include water.

### <Second Step>

The second step is a step for calculating an energy change (ΔG₂) between the bound state (λ=0) where the compound and the protein are bound, and the unbound state (λ=1) where the compound and the protein are not bound.

The bound state (λ=0) means a state where the interaction between the compound and the protein is the strongest.

The unbound state (λ=1) means a state where there is no interaction between the compound and the protein.

The second step contains at least the following first to fifth processes, and may further contain other processes according to the necessity.

First process: a process for determining a distance (Dₜₕ), within which structure sampling is performed
Second process: a process for calculating a binding energy change (ΔG₂₁) between the compound and the protein which are spaced within a distance equal to or shorter than the distance (Dₜₕ) in a state (λ=λm) that is between the bound state (λ=0) and the unbound state (λ=1), in which a state where a distance between the compound and the protein is equal to or shorter than the distance (Dₜₕ) is present
Third process: a process for calculating a solvation energy change (ΔG₂₃) between the solvent and the compound with ignoring an influence of the protein in the unbound state (λ=1) and the state (λ=λn) that can be regarded as the same to the unbound state (λ=1)
Fourth process: a process for calculating a binding energy change (ΔG₂₂) between the compound and the protein in a state between the state (λ=λm) and the state (λ=λn), by interpolating the state (λ=λm) and the state (λ=λn) Fifth process: a process for calculating a correction term (ΔG₂₄) with respect to a standard state, based on a volume of a space calculated from the distance (Dₜₕ)

### —First Process—

The first process is appropriately selected depending on the intended purpose without any limitation, provided that the first process is a process for determining a distance (Dₜₕ), within which structure sampling is performed, based on a distance between the compound and the protein in the bound state (λ=0).

The distance between the compound and the protein is preferably a distance between a center of gravity of the compound, and a center of gravity of a space formed by linking centers of gravity of a plurality of amino acid residues constituting a binding site in the protein.

The distance (Dₜₕ) is preferably selected from distances between 90% and 100% from a minimum value in a frequency distribution of a distance that is a result obtained by simulating the distance between the compound and the protein in the bound state (λ=0).

One example of a determination method of the distance (Dₜₕ) is explained.

First, a distance between the compound and the protein in the bound state (λ=0) is plotted with simulation time by a molecular dynamics (MD) method. One example thereof is depicted in FIG. 4. Based on the obtained plot, any of distances that are between 90% and 100% from the minimum value of the distance between the compound and the protein in the frequency distribution is determined as the distance (Dₜₕ). The distance (Dₜₕ) can be always determined as 100%. In this case, however, a scope for which structure sampling is performed becomes unnecessarily wide, if the distance, which is irregularly large during the simulation, is determined as the (Dₜₕ). Accordingly, the distance is preferably selected from the range between 90% and 100% from the minimum value.

### —Second Process—

The second process is appropriately selected depending on the intended purpose without any limitation, provided that the second process is a process for calculating a binding energy change (ΔG₂₁) between the compound and the protein within a distance equal to or shorter than the distance (Dₜₕ) on a state (λ=λm) that is a state between the bound state (λ=0) and the unbound state (λ=1), the state (λ=λm) including a state in which a distance between the compound and the protein is equal to or shorter than the distance (Dₜₕ).

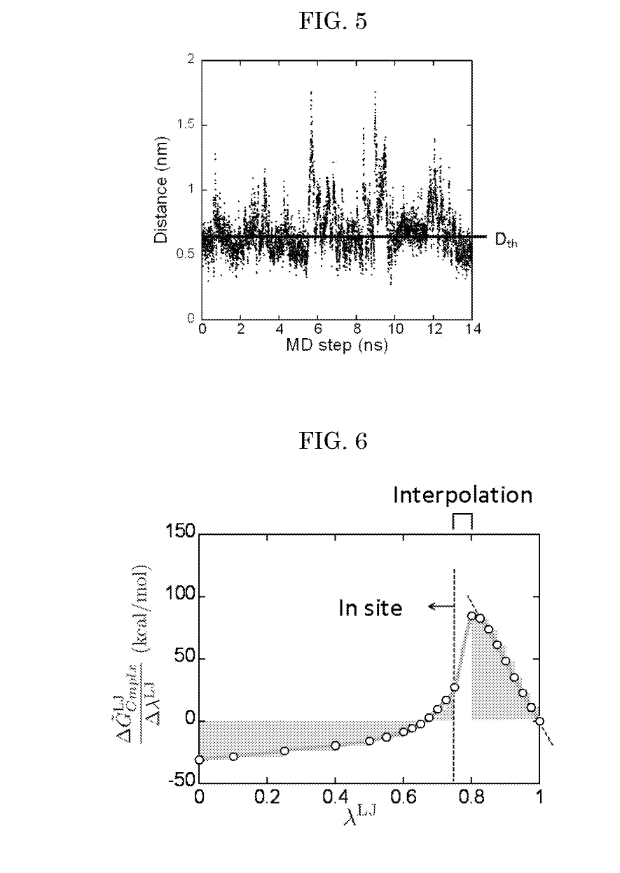

One example of the second process is described below. In the second process, a distance between the compound and the protein in a state between the bound state (λ=0) and the unbound state (λ=1) is plotted with simulation time by a molecular dynamics (MD) method. One example thereof is depicted in FIG. 5. In the state (λ=λm) where the distance between the compound and the protein, which is equal to or shorter than the distance (Dₜₕ), is present as depicted in FIG. 5, structure sampling is performed within the distance equal to or shorter than the distance (Dₜₕ). In FIG. 5, the distance Dₜₕ is set to 0.7 nm, and structure sampling is performed when the distance between the compound and the protein is 0.7 nm or shorter.

### —Third Process—

The third process is appropriately selected depending on the intended purpose without any limitation, provided that the third process is a process for calculating a change in solvation energy (ΔG₂₃) between the solvent and the compound in the unbound state (λ=1) and a state (λ=λn) that can be regarded as the same to the unbound state (λ=1), with ignoring an influence of the protein.

The state that can be regarded as the same to the unbound state is a state that is a state between the bound state (λ=0) and the unbound state (λ=1), and is a state that can be judged as that there is hardly any interaction between the compound and the protein.

Note that, λm and λn satisfy the relation of 0≦λm<Δn<1.

### —Fourth Process—

The fourth process is appropriately selected depending on the intended purpose without any limitation, provided that the fourth process is a process for calculating a change in binding energy (ΔG₂₂) between the compound and the protein in a state between the state (λ=λm) and the state (λ=λn), with interpolating from the state (λ=λm) and the state (λ=λn).

One example of a flow of the second process to the fourth process is explained here.

In this example, explanations are provided by taking a disappearance process of the Lennard-Jones (LJ) interaction illustrated in FIG. 6, as an example.

First, a change (ΔG₂₁) in binding energy between the compound and the protein is calculated with samples whose distance between a compound and a protein is within the distance (Dₜₕ) from the bound state (λ^{LJ}=0) to the unbound state (λ^{LJ}=1) based on the distance Dₜₕ determined by the first process. As the interaction between the compound and the protein weakens, it becomes a state where there is no sample within the distance (Dₜₕ) (around λ^{LJ}=0.75 in FIG. 6). The calculation is performed until such the state.

Next, a change (ΔG₂₃) in solvation energy between the solvent and the compound is calculated from the unbound state (λ^{LJ}=1) to the bound state (λ^{LJ}=0) until the limit at which it can be judged that there is hardly any interaction between the compound and the protein. In FIG. 6, the calculation was carried out to around λ^{LJ}=0.8.

Regarding the region (0.75<λ^{LJ}<0.8) between the regions within which the calculation was performed above, the energy change (ΔG₂₂) is calculated by interpolating from the results of λ^{LJ}=0.75 and λ^{LJ}=0.8.

### —Fifth Process—

The fifth process is appropriately selected depending on the intended purpose without any limitation, provided that it is calculating a correction term (ΔG₂₄) with respect to a standard state based on a volume of a space calculated from the distance (Dₜₕ).

One example of the fifth process is explained.

FIG. 7 is a diagram illustrating a change in the state of the compound (2) and the protein (1).

The binding free energy (ΔG°) to be calculated based on the state change of FIG. 7 can be calculated, for example, by the following expressions.

$$Δ {G}^{o} = Δ {\tilde{G}}_{Cmplx} - Δ {\tilde{G}}_{Solv} + Δ {\tilde{G}}_{Vol}^{{V}^{o} \to {V}^{site}}$$

$$Δ {\tilde{G}}_{Vol}^{{V}^{o} \to {V}^{site}} = - {k}_{B} T ln ( \frac{{V}^{site}}{{V}^{o}} )$$

In FIG. 7 and the expressions above, V⁰ represents a standard state volume, V^{C} represents a unit cell volume in a composition of the compound and the protein, and V^{site} represents a volume of a bind pocket of the protein.

Among the two expressions above, the left hand member of the bottom expression corresponds to a correction term (ΔG₂₄).

A calculation program used in the second step is appropriately selected depending on the intended purpose without any limitation, and examples thereof include a molecular dynamics calculation program. Examples of the molecular dynamics calculation program include gromacs.

In the calculation method of binding free energy, it is preferred that the binding free energy be calculated separately for Coulomb interaction and for Lennard-Jones (LJ) interaction, and the binding free energy for the Coulomb interaction be calculated followed by calculating the binding free energy for the Lennard-Jones interaction.

The free energy is state variable, and thus typically it is not influenced by a process. When the Lennard-Jones interaction is made disappeared first, however, atoms come extremely close to each other due to the remained Coulomb interaction (which gives large interaction energy compared to the Lennard-Jones interaction). Therefore, a calculation may be difficult to perform. When the Coulomb interaction is made disappeared first, on the other hand, the Lennard-Jones interaction can be treated as a soft core potential (in order to avoid a case where different atoms are brought extremely close to the same location), and therefore an accurate calculation can be performed.

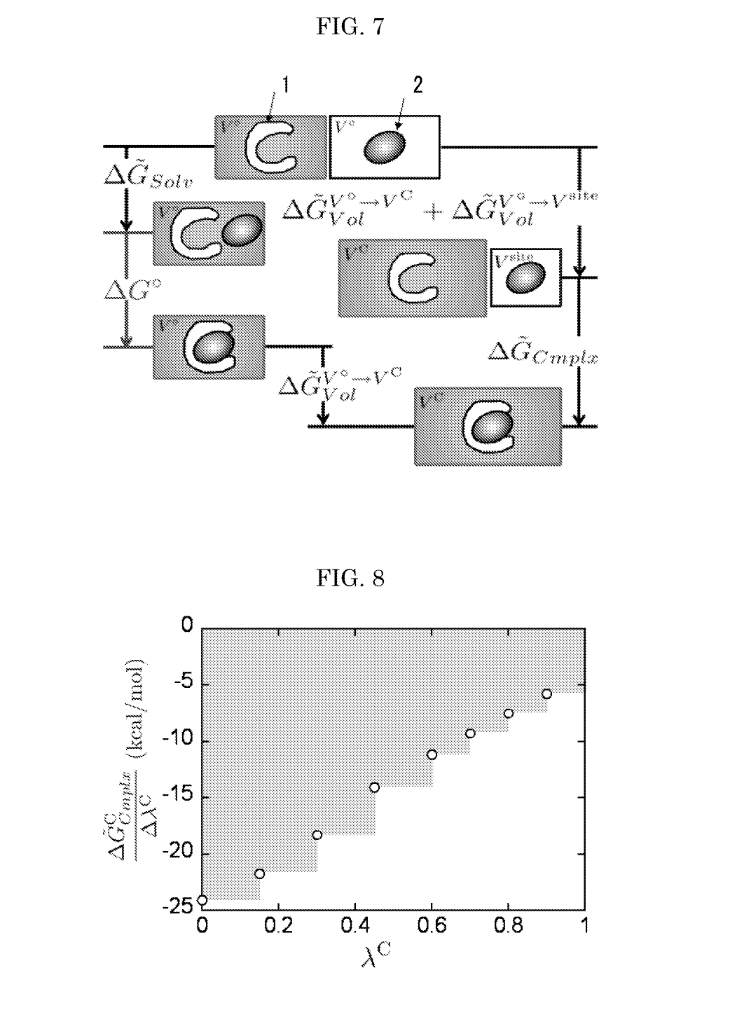

One example of a disappearance process of the Coulomb interaction between the compound and the protein is depicted in FIG. 8.

### (Screening Method of Compound)

The disclosed screening method of a compound contains: calculating binding free energy of a protein with a plurality of compounds in accordance with the disclosed calculation method of binding free energy; and selecting a compound based on the calculated binding free energy.

A method for selecting the plurality of compounds is appropriately selected depending on the intended purpose without any limitation, and examples thereof include a method for selecting the plurality of compounds from a compound library, which is to be a screening target, based on information about attributes of compounds.

The selecting the compound is appropriately selected depending on the intended purpose without any limitation, and examples thereof include selecting a compound having an optimal value amount the calculated values of the binding free energy, as a drug candidate molecule suitable for the protein.

### (Program)

The disclosed program is a program that causes a computer to execute at least a first step and a second step.

The program calculates binding free energy between a compound and a protein in a solvent.

The first step and the second step are respectively the first step and the second step of the disclosed calculation method of binding free energy.

The program can be formed with various conventional programming languages depending on a configuration of a computer system for use, and a type or version of an operation system.

The program may be recorded on a recording medium, such as an internal hard disk, and an external hard disk, or may be recorded on a recording medium, such as a compact disc read only memory (CD-ROM), a digital versatile disk read only memory (DVD-ROM), a magneto-optical disk (MO disk), and universal serial bus (USB) flash drive (USB memory). In the case where the program is recorded on a recording medium, such as CD-ROM, DVD-ROM, MO disk, and USB memory, the program can be directly used via a recording device reading device equipped with a computer system, or is used by installing on a hard disk according to the necessity at any time. It is also possible that the program is recorded on an external memory region (e.g., another computer), which can be accessed from a computer system through an information communication network, and the program is directly used from the external storage region via the information communication network, or is used by installing a hard disk according to the necessity at any time.

### (Recording Medium Readably by Computer)

The recording medium readable by a computer stores therein the disclosed program.

The recording medium readable by a computer is appropriately selected depending on the intended purpose without any limitation, and examples thereof include an internal hard disk, an external hard disk, CD-ROM, DVD-ROM, a MO disk, and an USB memory.

### (Calculation Device of Binding Free Energy)

The disclosed calculation device of binding free energy contains a computer, and the recording medium readable by the computer.

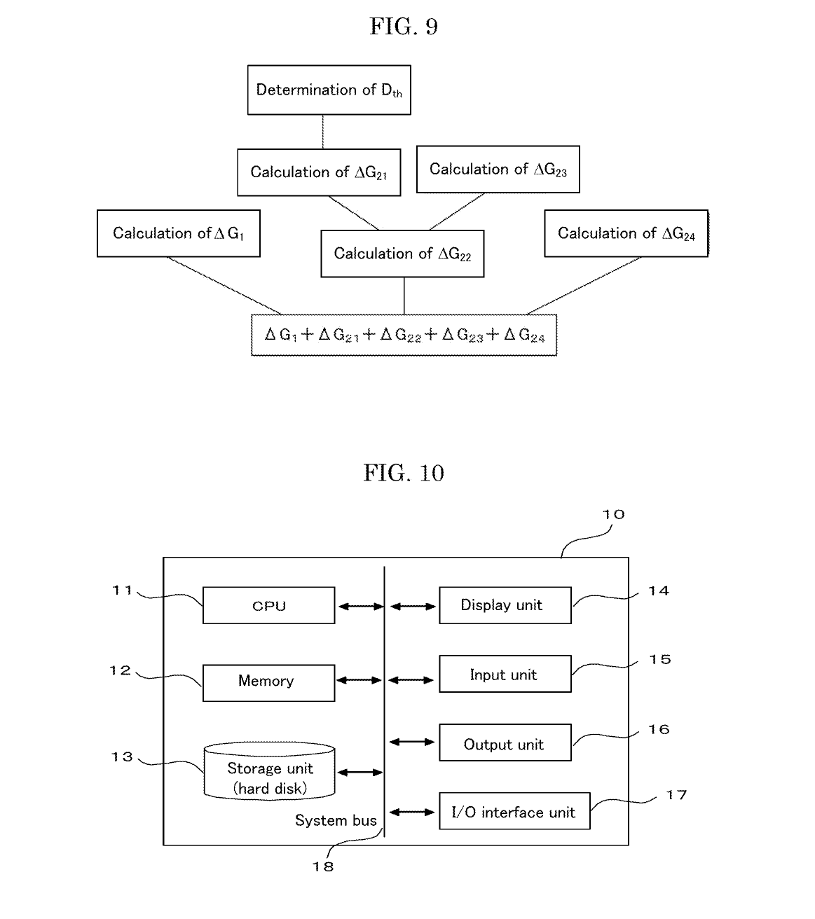

A flow chart of one example of the disclosed calculation method of binding free energy is depicted in FIG. 9.

First, the solvation energy (ΔG₁) between the solvent and the compound is calculated (calculation of ΔG₁).

Next, a distance (Dₜₕ), within which structure sampling is performed, is determined based on a distance between the compound and the protein in the bound state (λ=0) (determination of Dₜₕ).

Next, a change in binding energy (ΔG₂₁) between the compound and the protein is calculated within a distance equal to or shorter than the distance (Dₜₕ) in a state (λ=λm) that is a state between the bound state (λ=0) and the unbound state (λ=1), the state (λ=λm) including a state in which a distance between the compound and the protein is equal to or shorter than the distance (Dₜₕ) (calculation of ΔG₂₁).

Next, a change in solvation energy (ΔG₂₃) between the solvent and the compound in the unbound state (λ=1) and a state (λ=λn) that can be regarded as the same to the unbound state (λ=1), is calculated with ignoring an influence of the protein (calculation of ΔG₂₃).

Next, a change in binding energy (ΔG₂₂) between the compound and the protein in a state between the state (λ=λm) and the state (λ=λn), is calculated with interpolating from the state (λ=λm) and the state (λ=λn) (calculation of ΔG₂₂).

Next, a correction term (ΔG₂₄) with respect to a standard state is calculated based on a volume of a space calculated from the distance (Dₜₕ) (calculation of ΔG₂₄).

Finally, the sum of ΔG₁, ΔG₂₁, ΔG₂₂, ΔG₂₃, and ΔG₂₄ is obtained.

In the manner as described above, binding free energy between a compound and a protein in a solvent can be calculated.

Note that, as illustrated in FIG. 9, there is no limitation in the order for performing a calculation of ΔG₁, and other processes (determination of Dₜₕ, calculation of ΔG₂₁, calculation of ΔG₂₂, calculation of ΔG₂₃, and calculation of ΔG₂₄). Moreover, there is not limitation in the order for performing the calculation of ΔG₂₄, and the calculations of ΔG₂₁, ΔG₂₂, and ΔG₂₃. The calculation of ΔG₂₂ is preferably performed after determining the state (λ=λm) through the calculation of ΔG₂₁, and after determining the state (λ=λn) through the calculation of ΔG₂₃.

A structural example of a hardware of the disclosed calculation device of binding free energy is illustrated in FIG. 10.

The calculation device 10 of binding free energy is composed, for example, by connecting a CPU 11, a memory 12, a storage unit 13, a display unit 14, an input unit 15, an output unit 16, an I/O interface unit 17, etc. via a system bus 18.

The CPU (Central Processing Unit) 11 is configured to operate (e.g., four arithmetic operation, and comparison operation), and to control operations of a hardware and a software.

The memory 12 is a memory, such as a random access memory (RAM), and read only memory (ROM). The RAM saves an operation system (OS) and application programs read from the ROM and the storage unit 13, and functions as a main memory and work area of the CPU 11.

The storage unit 13 is a device for storing various programs and data, and examples thereof is a hard dist. In the storage unit 13, a program performed by the CPU 11, data required for carrying out a program, OS, etc. are stored.

The program is stored in the storage unit 13, loaded on RAM (a main memory) of the memory 12, and is carried out by the CPU 11.

The display unit 14 is a display device, and examples thereof include display devices, such as a CRT monitor, and a liquid crystal panel.

The input unit 15 is an input device for various data, and examples thereof include a key board, and a pointing device (e.g., a mouse).

The output unit 16 is an output device of various data, and examples thereof include a printer.

The I/O interface unit 17 is an interface for connecting with various outer devices. For example, the I/O interface unit 17 allows input and output of data of CD-ROM, DVD-ROM, a MO disk, or an USB memory.

The disclosed calculation method of binding free energy can solve the aforementioned various problems in the art, can achieve the aforementioned object, and can provide a method, which accurately calculate binding free energy between a protein and a compound.

The disclosed screening method of a compound can solve the aforementioned various problems in the art, can achieve the aforementioned object, and can provide a method, which efficiently screens a compound.

The disclosed program can solve the aforementioned various problems in the art, can achieve the aforementioned object, and can provide a program, which accurately calculates binding free energy between a protein and a compound.

The disclosed calculation device of binding free energy can solve the aforementioned various problems in the art, can achieve the aforementioned object, and can provide a device, which accurately calculates binding free energy between a protein and a compound.

### Example

The disclosed calculation method of binding free energy is explained through Example hereinafter, but Example shall not be construed to as limiting the disclosed calculation method of binding free energy.

Using the disclosed calculation method of binding free energy, binding free energy of a protein and ligands in water was calculated, where [1fkj] and [1fkg] registered in the protein data bank (PDB) were used as the protein.

[1fkj]

### Protein: FK506 BINDING PROTEIN

### Ligand: 8-DEETHYL-8-[BUT-3-ENYL]-ASCOMYCIN, C₄₄H₆₉NO₁₂

(molecular weight: 803)
[1fkg]

### Protein: FK506 BINDING PROTEIN

Ligand: 1,3-DIPHENYL-1-PROPYL-1-(3,3-DIMETHYL-1,2-DIOXYPENTYL)-2-PIPERIDINE CARBOXYLATE, C₂₈H₃₅NO₄ (molecular weight: 449)

In the calculation below, gromacs (Groningen Machine for Chemical Simulations), which was a molecular dynamics calculation program, was used.

As for a distance between the compound and the protein when determining a distance (Dₜₕ) within which structure sampling would be performed, used was a distance from a center of gravity of the compound, and a center of gravity of a space formed by linking centers of gravity of a plurality of amino acid residues constituting a binding site in the protein.

The distance Dₜₕ, within which structure sampling would be performed, was determined in the following manner.

A distance between the compound and the protein in the bound state (λ=0) was plotted with simulation time using gromacs. The distance, which was 95% from the minimum value of the distance between the compound and the protein in the frequency distribution based on the obtained plot, was determined as the (Dₜₕ). The specific distance (Dₜₕ) was 0.77 nm in the calculation of [1fkj], and was 0.85 nm in the calculation of

[1fkg].

In accordance with the disclosed method, ΔG₁, and ΔG₂ (ΔG₂₁, ΔG₂₂, ΔG₂₃, ΔG₂₄) were calculated.

Note that, the maximum value of λ=λm at the time of calculating ΔG₂₁ was determined by setting the maximum value of λ with which a structure containing the compound in the distance Dₜₕ did not appear, as λm. Moreover, the minimum value at the time of calculating ΔG₂₃ is determined by setting the minimum value of λ with which it started to match with a change of the free energy of the compound in the solvent, as λn.

Note that, the calculation was performed separately for the Coulomb interaction and for the Lennard-Jones interaction. The binding free energy was first calculated for the Coulomb interaction, and then calculated for the Lennard-Jones interaction. As a result, the Lennard-Jones interaction could be treated as a soft core potential, and therefore an accurate calculation was possible.

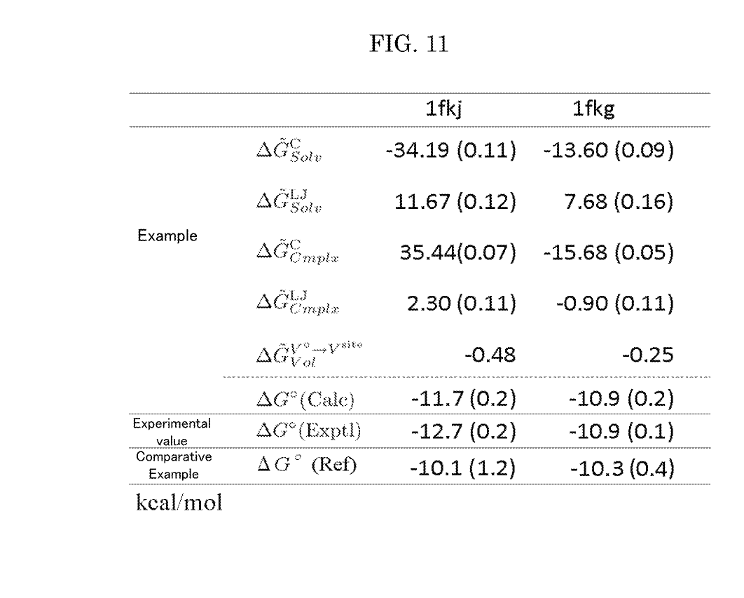

The calculation results are depicted in FIG. 11.

Example in FIG. 11 is the results of Example. The experimental value is the experimental value disclosed in Holt et al., J. Am. Chem. Soc. 1993, 115, 9925-9938. Comparative Example is the calculation value disclosed in Wang et al., Biophysical Journal Vol. 91, 2798-2814, and is the calculation value in the case where the restriction with a spring is performed.

The calculation result (−10.9 kcal/mol) of 1fkg of Example is matched to the experimental value (−10.9 kcal/mol), and is more excellent than the calculation result (−10.3 kcal/mol) of Comparative Example.

The calculation result (−11.7 kcal/mol) of 1fkj of Example is a value slightly different from the experimental value (−12.7 kcal/mol), but is a value closer to the experimental value than Comparative Example, (−10.1 kcal/mol). Comparative Example of 1fkj and the experimental value of 1fkj are largely different from each other, probably because a molecule of the ligand is large. In Example, the calculation result with relatively high accuracy could be attained even when the ligand molecule was large.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the sprit and scope of the invention.

What is claimed is:

1. A calculation method of binding free energy between a compound and a protein in a solvent, the method comprising:
calculating solvation energy (ΔG₁) between the solvent and the compound; and
calculating an energy change (ΔG₂) between a bound state (λ=0) where the compound and the protein are bound, and an unbound state (λ=1) where the compound and the protein are not bound,
wherein the calculating the energy change (ΔG₂) comprises:
determining a distance (Dₜₕ), within which structure sampling is performed, based on a distance between the compound and the protein in the bound state (λ=0);
calculating a change in binding energy (ΔG₂₁) between the compound and the protein within a distance equal to or shorter than the distance (Dₜₕ) on a state (λ=λm) that is a state between the bound state (λ=0) and the unbound state (λ=1), the state (λ=λm) including a state in which a distance between the compound and the protein is equal to or shorter than the distance (Dₜₕ),
calculating a change in solvation energy (ΔG₂₃) between the solvent and the compound in the unbound state (λ=1) and a state (λ=λn) that can be regarded as the same to the unbound state (λ=1), with ignoring an influence of the protein,
calculating a change in binding energy (ΔG₂₂) between the compound and the protein on a state between the state (λ=λm) and the state (λ=λn), with interpolating from the state (λ=λm) and the state (λ=λn), and
calculating a correction term (ΔG₂₄) with respect to a standard state, based on a volume of a space calculated from the distance (Dₜₕ).

2. The calculation method according to claim 1, wherein the solvent is water.

3. The calculation method according to claim 1, wherein the distance between the compound and the protein is a distance between a center of gravity of the compound, and a center of gravity of a space formed by linking centers of gravity of a plurality of amino acid residues constituting a binding site in the protein.

4. The calculation method according to claim 1, wherein the distance (Dₜₕ) is selected from distances between 90% and 100% from a minimum value in a frequency distribution of a distance that is a result obtained by simulating the distance between the compound and the protein in the bound state (λ=0).

5. The calculation method according to claim 1, wherein the binding free energy is calculated separately for Coulomb interaction and for Lennard-Jones interaction, and the binding free energy is calculated for the Coulomb interaction, followed by calculating for the Lennard-Jones interaction.

6. A screening method of a compound, comprising:
calculating binding free energy of a protein with a plurality of compounds in accordance with a calculation method of binding free energy; and
selecting the compound based on the calculated binding free energy,
wherein the calculation method of binding free energy between a compound and a protein in a solvent, the method containing:
calculating solvation energy (ΔG₁) between the solvent and the compound; and
calculating an energy change (ΔG₂) between a bound state (λ=0) where the compound and the protein are bound, and an unbound state (λ=1) where the compound and the protein are not bound,
wherein the calculating the energy change (ΔG₂) includes:
determining a distance (Dₜₕ), within which structure sampling is performed, based on a distance between the compound and the protein in the bound state (λ=0);
calculating a change in binding energy (ΔG₂₁) between the compound and the protein within a distance equal to or shorter than the distance (Dₜₕ) on a state (λ=λm) that is a state between the bound state (λ=0) and the unbound state (λ=1), the state (λ=λm) including a state in which a distance between the compound and the protein is equal to or shorter than the distance (Dₜₕ),
calculating a change in solvation energy (ΔG₂₃) between the solvent and the compound in the unbound state (λ=1) and a state (λ=λn) that can be regarded as the same to the unbound state (λ=1), with ignoring an influence of the protein,
calculating a change in binding energy (ΔG₂₂) between the compound and the protein on a state between the state (λ=λm) and the state (λ=λn), with interpolating from the state (λ=λm) and the state (λ=λn), and
calculating a correction term (ΔG₂₄) with respect to a standard state, based on a volume of a space calculated from the distance (Dₜₕ).

7. The screening method according to claim 6, wherein the solvent is water.

8. The screening method according to claim 6, wherein the distance between the compound and the protein is a distance between a center of gravity of the compound, and a center of gravity of a space formed by linking centers of gravity of a plurality of amino acid residues constituting a binding site in the protein.

9. The screening method according to claim 6, wherein the distance (Dₜₕ) is selected from distances between 90% and 100% from a minimum value in a frequency distribution of a distance that is a result obtained by simulating the distance between the compound and the protein in the bound state (λ=0).

10. The screening method according to claim 6, wherein the binding free energy is calculated separately for Coulomb interaction and for Lennard-Jones interaction, and the binding free energy is calculated for the Coulomb interaction, followed by calculating for the Lennard-Jones interaction.

11. A program for causing a computer to execute:
calculating solvation energy (ΔG₁) between the solvent and the compound; and
calculating an energy change (ΔG₂) between a bound state (λ=0) where the compound and the protein are bound, and an unbound state (λ=1) where the compound and the protein are not bound,
wherein the calculating the energy change (ΔG₂) includes:
determining a distance (Dₜₕ), within which structure sampling is performed, based on a distance between the compound and the protein in the bound state (λ=0);
calculating a change in binding energy (ΔG₂₁) between the compound and the protein within a distance equal to or shorter than the distance (Dₜₕ) on a state (λ=λm) that is a state between the bound state (λ=0) and the unbound state (λ=1), the state (λ=λm) including a state in which a distance between the compound and the protein is equal to or shorter than the distance (Dₜₕ),
calculating a change in solvation energy (ΔG₂₃) between the solvent and the compound in the unbound state (λ=1) and a state (λ=λn) that can be regarded as the same to the unbound state (λ=1), with ignoring an influence of the protein,
calculating a change in binding energy (ΔG₂₂) between the compound and the protein on a state between the state (λ=λm) and the state (λ=λn), with interpolating from the state (λ=λm) and the state (λ=λn), and
calculating a correction term (ΔG₂₄) with respect to a standard state, based on a volume of a space calculated from the distance (Dₜₕ).

12. The program according to claim 11, wherein the solvent is water.

13. The program according to claim 11, wherein the distance between the compound and the protein is a distance between a center of gravity of the compound, and a center of gravity of a space formed by linking centers of gravity of a plurality of amino acid residues constituting a binding site in the protein.

14. The program according to claim 11, wherein the distance (Dₜₕ) is selected from distances between 90% and 100% from a minimum value in a frequency distribution of a distance that is a result obtained by simulating the distance between the compound and the protein in the bound state (λ=0).

15. The program according to claim 11, wherein the binding free energy is calculated separately for Coulomb interaction and for Lennard-Jones interaction, and the binding free energy is calculated for the Coulomb interaction, followed by calculating for the Lennard-Jones interaction.

16. A calculation device of binding free energy, comprising:
a computer; and
a recording medium readable by the computer, where the recording medium stores therein a program for causing the computer to execute:
calculating solvation energy (ΔG₁) between the solvent and the compound; and
calculating an energy change (ΔG₂) between a bound state (λ=0) where the compound and the protein are bound, and an unbound state (λ=1) where the compound and the protein are not bound,
wherein the calculating the energy change (ΔG₂) comprises:
determining a distance (Dₜₕ), within which structure sampling is performed, based on a distance between the compound and the protein in the bound state (λ=0);
calculating a change in binding energy (ΔG₂₁) between the compound and the protein within a distance equal to or shorter than the distance (Dₜₕ) on a state (λ=λm) that is a state between the bound state (λ=0) and the unbound state (λ=1), the state (λ=λm) including a state in which a distance between the compound and the protein is equal to or shorter than the distance (Dₜₕ),
calculating a change in solvation energy (ΔG₂₃) between the solvent and the compound in the unbound state (λ=1) and a state (λ=λn) that can be regarded as the same to the unbound state (λ=1), with ignoring an influence of the protein,
calculating a change in binding energy (ΔG₂₂) between the compound and the protein on a state between the state (λ=λm) and the state (λ=λn), with interpolating from the state (λ=λm) and the state (λ=λn), and
calculating a correction term (ΔG₂₄) with respect to a standard state, based on a volume of a space calculated from the distance (Dₜₕ).

17. The calculation device according to claim 16, wherein the solvent is water.

18. The calculation device according to claim 16, wherein the distance between the compound and the protein is a distance between a center of gravity of the compound, and a center of gravity of a space formed by linking centers of gravity of a plurality of amino acid residues constituting a binding site in the protein.

19. The calculation device according to claim 16, wherein the distance (Dₜₕ) is selected from distances between 90% and 100% from a minimum value in a frequency distribution of a distance that is a result obtained by simulating the distance between the compound and the protein in the bound state (λ=0).

20. The calculation device according to claim 16, wherein the binding free energy is calculated separately for Coulomb interaction and for Lennard-Jones interaction, and the binding free energy is calculated for the Coulomb interaction, followed by calculating for the Lennard-Jones interaction.
